(19) United States
(12) Patent Application Publication
(10) Pub. No.: US 2016/0001625 A1
(43) Pub. Date: Jan. 7, 2016

(54) ROTARY DAMPER FOR A VEHICLE

(71) Applicant: ZF FRIEDRICHSHAFEN AG, Friedrichshafen (DE)

(72) Inventor: Daniel WOLF, Friedrichshafen (DE)

(73) Assignee: ZF FRIEDRICHSHAFEN AG, Friedrichshafen (DE)

(21) Appl. No.: 14/770,952

(22) PCT Filed: Feb. 3, 2014
(86) PCT No.: PCT/EP2014/052004

§ 371 Date: Aug. 27, 2015

(30) Foreign Application Priority Data
Feb. 28, 2013 (DE) 10 2013 203 431.8

(51) Int. Cl. B60G 17/06; B60G 13/00

(52) U.S. Cl. CPC B60G 17/06; B60G 13/00; B60G 2202/22; B60G 2204/4191

(57) ABSTRACT

A rotary damper for a vehicle, for damping relative movements between vehicle wheels and the vehicle body. The damper has at least one gear assembly that converts the relative movement into rotation movement and is connected to at least one electric machine (2) in such manner so that actively controllable damping of the relative movement is possible.

This application is a National Stage completion of PCT/EP2014/052004 filed Feb. 3, 2014, which claims priority from German patent application serial no. 10 2013 203 431.8 filed Feb. 28, 2013.

### FIELD OF THE INVENTION

The present invention concerns a rotary damper for a vehicle, for damping relative movements.

### BACKGROUND OF THE INVENTION

From automotive technology linear dampers are known, for the damping of linear movements. Furthermore, from the document DE 10 2008 042 389 A, a rotary damper is also known, which consists of an inner, fixed part and an outer part that can rotate relative to the inner part, the outer part being connected to a lever for producing the rotation. Between the inner part and the outer part there is arranged a frictional clutch in the form of a disk clutch, whose disks are connected fixed, in alternation, to the two parts. In the area of the lever, the outer part is fixed to a first component of a spindle gear, which can move in rotation on balls over a second component and during this, undergoes axial movement that is guided by a ramp on the second component. Accordingly, rotational movement of the outer part produced by the spindle drive is converted to axial movement of the first component and thus also of the outer part, in order to bring the friction surfaces of the clutch into contact. This brings about a coupling of the inner and outer parts, which brakes the outer part and therefore damps the rotational movement.

### SUMMARY OF THE INVENTION

The purpose of the present invention is to propose a rotary damper with as compact a structure as possible.

According to the invention, that objective is achieved by virtue of the characteristics and advantageous design features that emerge from the description and the drawings.

For a compact structure a rotary damper is proposed, preferably fitting in a vehicle in order to damp relative movements between vehicle wheels and the vehicle body, the damper comprising at least one gear assembly, that converts the relative movement into rotational movement, and at least one electric machine, which are functionally connected with one another in such manner that damping of the relative movement can be actively controlled.

In this way the relative movement, after being converted to rotational movement, can be damped as desired by means of the electric machine connected to the gear assembly. To further improve the braking action, in the context of the present invention it can be provided that at least one dynamic brake is used. Dynamic brakes are those whose braking force is speed-dependent. With the dynamic brake the electric machine and so also the gear assembly can be braked appropriately in order to obtain a desired damping of the relative movement. As the dynamic brake, preferably at least one eddy current brake, a hydrodynamic brake or the like can be used.

In a preferred embodiment variant of the invention it can be provided that when an eddy current brake is used, this is connected or arranged relative to the connection between the at least one gear assembly and the electric machine, in parallel, in series or in a power-branched configuration.

To produce a particularly space-saving arrangement of the eddy current brake in the proposed rotary damper, it can be provided that the eddy current brake has for example a drum-shaped structure, arranged for example coaxially with the rotor of the electric machine. It is also conceivable for the eddy current brake to have for example a disk-shaped structure such that the disk-shaped plates can each be associated with a respective end side of the electric machine.

The magnetic flux for producing the eddy currents can be produced by the stator of the electric machine. For this, as an example the stator plate or a similar component of the electric machine can for example have grooves or recesses which are rectangular, V-shaped or shaped in some other way, in order to produce a stray field on the outside. Alternatively, the stator can also be made longer than the rotor, and the drum of the eddy current brake can project into the stator of the electric machine. If the eddy current brake is designed with a disk shape or a plate shape, then, for example, to produce the required stray field an extension of the stator or of the pole-pieces of the electric machine can be provided so that magnetic flux is generated in the disks or plates of the eddy current brake.

Beside the disk-shaped or drum-shaped designs, conical or similarly designed embodiments or combinations thereof can be used as eddy current brakes, which project at least in part into the stator or which surround it. Furthermore, to produce the eddy currents permanent magnets or the like can be used, which can be attached preferably on the housing of the rotary damper in the area of the outside of the stator or, for example, on the drum or the plates themselves. Instead of permanent magnets external excitation by means of a coil arrangement or the like is also conceivable, wherein for cost reasons it is preferable to use a coil arrangement with claw poles analogous to a claw pole generator or the like.

Alternatively to or in combination with the eddy current brake, a hydrodynamic brake or clutch can be used, As the medium for this, aside from oil it is also possible for example to use a magneto-rheological or electro-rheological fluid, whose viscosity can be adjusted by means of the magnetic or electric field, respectively.

As an alternative to the electric machine designed as an internal-rotor machine, in the proposed rotary damper it is also possible to use an external-rotor electric machine. For example, a metallic cylinder, forming an external rotor arrangement of the external-rotor machine, can at the same time form the eddy current brake, which, by virtue of a further stator or a permanent magnet, is located in a magnetic flux for producing the eddy currents. Optionally, the magnetic flux can also be produced in the rotor of the external-rotor machine by a multi-component rotor arrangement or the like, such that between the components of the multi-component rotor arrangement a minimal air-gap is provided. The metallic portion of the rotor arrangement can for example consist of a metallic cylinder and the magnetic portion of the rotor arrangement for example of a cylindrical, non-magnetic holding arrangement for the magnets or suchlike. The magnet holding arrangement and the metallic cylinder are coupled to the gear assembly, for example in the form of a planetary gear assembly, in such manner that the magnet holding arrangement and the metallic cylinder move in opposite directions, Regardless of the design of the rotor arrangement of the electric machine the eddy current brake is, as it were, integrated in the rotor arrangement or contained therein. Other possible arrangements too are conceivable.

The proposed rotary damper can preferably be used for damping relative movements between vehicle wheels and a vehicle body. However other uses, for example in other vehicles are also possible,

### BRIEF DESCRIPTION OF THE DRAWINGS

Below, the present invention is explained in more detail with reference to the drawings, which show:

FIG. 1: A schematic view of a possible embodiment variant of a rotary damper with an electric machine and an eddy current brake connected in parallel upstream from a planetary gear assembly;

FIG. 2: A schematic view of a possible embodiment variant of a rotary damper with an alternative design of the eddy current brake arranged in parallel;

FIG. 3: A schematic view of a related embodiment variant of the rotary damper, with two planetary gear assemblies connected upstream from an electric machine and an eddy current brake arranged in series;

FIG. 4: A schematic view of a related embodiment variant of the rotary damper, with two planetary gear assemblies connected upstream from an electric machine and an eddy current brake arranged in a power-branched manner;

FIG. 5: A schematic view of another embodiment variant of the rotary damper, with two planetary gear assemblies connected upstream from an electric machine and an eddy current brake arranged in a power-branched manner;

FIG. 6: A schematic view of a further embodiment variant of the rotary damper, with an electric machine designed as an external-rotor machine;

FIG. 7: A schematic view of an alternative design of the rotary damper shown in FIG. 6;

FIG. 8: A cross-sectional view of a stator plate of the electric machine, with radial grooves arranged on the outer circumference; and

FIG. 9: An enlarged view of the stator plate in the area of a groove, showing the stray flux produced.

### DETAILED DESCRIPTION OF THE PREFERRED EMBODIMENTS

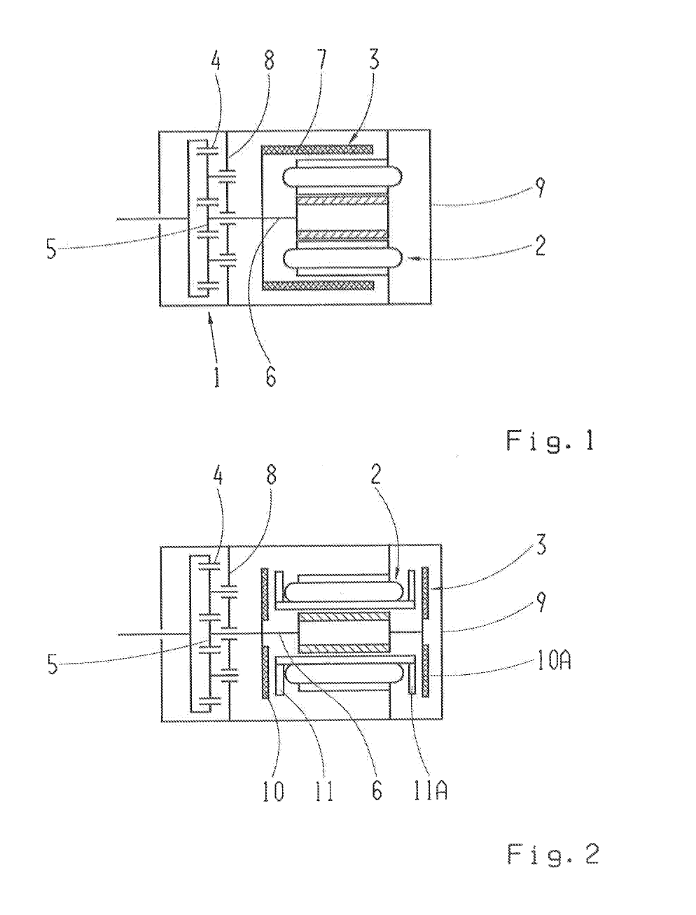

FIG. 1 is a possible embodiment variant of the rotary damper according to the invention, having a first planetary gearset 1 as the gear assembly and, connected downstream therefrom, an electric machine 2 with a parallel eddy current brake 3 in a drum-shaped configuration. A lever that transmits the relative movement is connected to a ring gear 4 of the planetary gearset 1, such that in a known way the ring gear 4 engages with planetary gearwheels mounted on a planetary carrier 8, the gearwheels in turn engage with a sun gear 5. For the parallel arrangement, the sun gear 5 is connected to a rotor 6 of the electric machine 2 and a drum 7 of the eddy current brake 3. The planetary carrier 8 is connected to a housing 9 of the rotary damper.

In this way the relative movement to be damped between two bodies or masses, particularly in a vehicle between a wheel and the vehicle body, is transmitted by way of a deflection lever as rotational movement to the planetary gear assembly 1 which, for example, increases the rotation speedal and reduces the torque introduced. The electric machine 2 is connected in parallel with the eddy current brake 3 on a common shaft. For example, the electric machine 2, designed as an electric motor or generator, drives the planetary gearwheels of the positionally fixed planetary carrier 8 by way of the sun gear 5, whereas in turn the planetary gearwheels mesh with the ring gear 4,

FIG. 2 shows an alternative design of the eddy current brake 3 in a disk or plate configuration. In this version, the eddy current brake 3 has for example two disk-shaped plates 10, 10A, each associated with an end side of the electric machine 2. The magnetic flux for producing the eddy currents of the eddy current brake 3 is created by an axially extended structure of the stator of the electric machine 2, wherein approximately ring disk shaped, angled portions 11, 11A are provided, which are directed approximately parallel to the disk-shaped plates 10, 10A of the eddy current brake 3. The angled portions 11, 11A can, for example, be in the form of extended pole-pieces of the stator of the electric machine 2.

In other respects, in the embodiment variant shown in FIG. 2, as in that of FIG. 1 the electric machine 2 is shown with a parallel eddy current brake 3, in both cases coupled to the sun gear 5 of the planetary gear assembly 1, with the ring gear 4 in turn connected to the lever (not shown) for transmitting the relative movement.

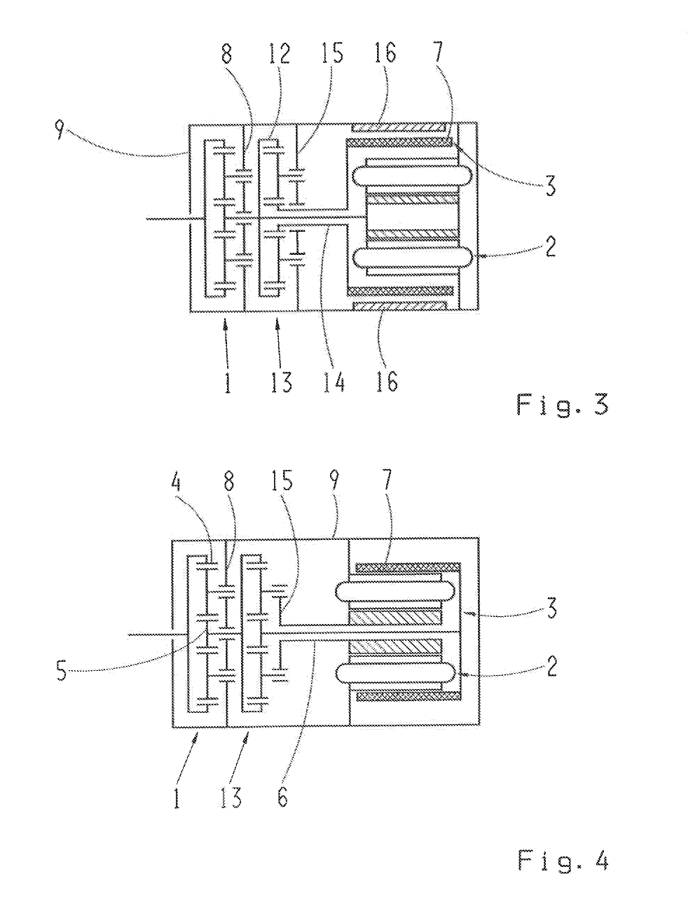

FIG. 3 shows another embodiment variant of the rotary damper, in which the electric machine 2 and the eddy current brake 3 are arranged in series. The relative movement is again transmitted by a lever to the ring gear 4 of the first planetary gear assembly 1, whereas for the series arrangement the sun gear 5 of the first planetary gear assembly 1 is connected to the rotor 6 of the electric machine 2 and to a ring gear 12 of a second planetary gear assembly 13, the second planetary gear assembly 13 being connected downstream from the first planetary gear assembly 12. A sun gear 14 of the second planetary gear assembly 13 is connected to the drum 7 of the eddy current brake 3. The planetary carrier 8 of the first planetary gear assembly 1 and the planetary carrier 15 of the second planetary gear assembly 13 are connected to the housing 9. In this series arrangement the second planetary gear assembly 13 is connected downstream from the first planetary gear assembly 1 provided for the electric machine 2, and the second planetary gear assembly 13 is functionally connected to the eddy current brake 3. In contrast to the previous embodiment variants, the magnetic flux for producing the eddy currents for the eddy current brake 3 is produced by permanent magnets 16 attached to the housing 9.

FIG. 4 shows a further embodiment variant of the rotary damper, in which the electric machine 2 is arranged with a power-branched eddy current brake 3. The ring gear 4 of the first planetary gear assembly 1 is again connected to the lever that transmits the relative movement, whereas for the power-branched arrangement the sun gear 5 of the first planetary gear assembly 1 is connected to the ring gear 12 of the second planetary gear assembly 13. The sun gear 14 of the second planetary gear assembly 13 is connected to the drum 7 of the eddy current brake 3. The planetary carrier 8 of the first planetary gear assembly 1 is connected to the housing 9, whereas the planetary carrier 15 of the second planetary gear assembly 13 is connected to the rotor 6 of the electric machine 2.

In this type of power-branched arrangement of the electric machine 2 and the eddy current brake 3, depending on the transmission ratio of the gear assembly the power-branching serves as overload protection for the electric machine 2. Due to the inertia of the rotor 6 and the planetary gear assemblies 1 and 13 connected upstream from the electric machine 2, externally introduced accelerations for example in the form of direction changes can block the branch driven by electric motor, so that in such a case the rotary movement is mostly damped by the eddy current brake 3.

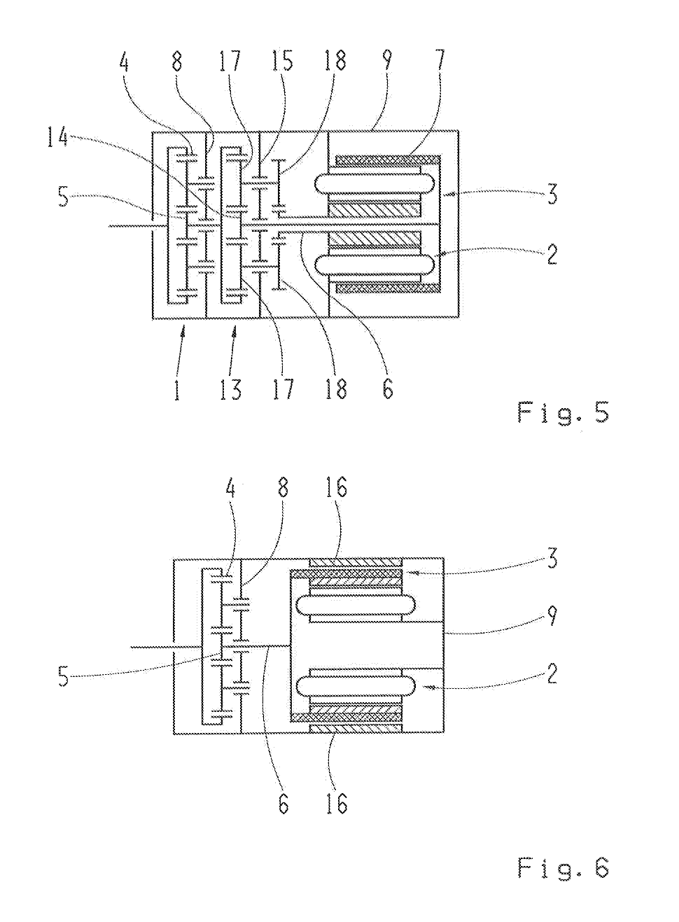

A further variant of the power-branching is shown in FIG. 5. In this embodiment variant of the rotary damper the lever transmitting the relative movement is connected to the ring gear 4 of the first planetary gear assembly 1 and for the power-branched arrangement the sun gear 5 of the first planetary gear assembly 1 is connected to the ring gear 12 of the second planetary gear assembly 13. The sun gear 14 of the second planetary gear assembly 13 is connected to the drum 7 of the eddy current brake 3, whereas the planetary carrier or web 8 of the first planetary gear assembly 1 and the planetary carrier or web 15 of the second planetary gear assembly 13 are both connected to the housing 9. In contrast to the previous embodiment variants, the second planetary gear assembly 13 comprises a double planetary set, wherein the first planetary gearwheels 17 of the double planetary set engage, on the one hand, with the sun gear 14 of the second planetary gear assembly 13 and, on the other hand, with the ring gear 12 of the second planetary gear assembly 13. The second planetary gearwheels 18 of the double planetary set engage with the rotor 6 of the electric machine 2 which is designed as a ring gear.

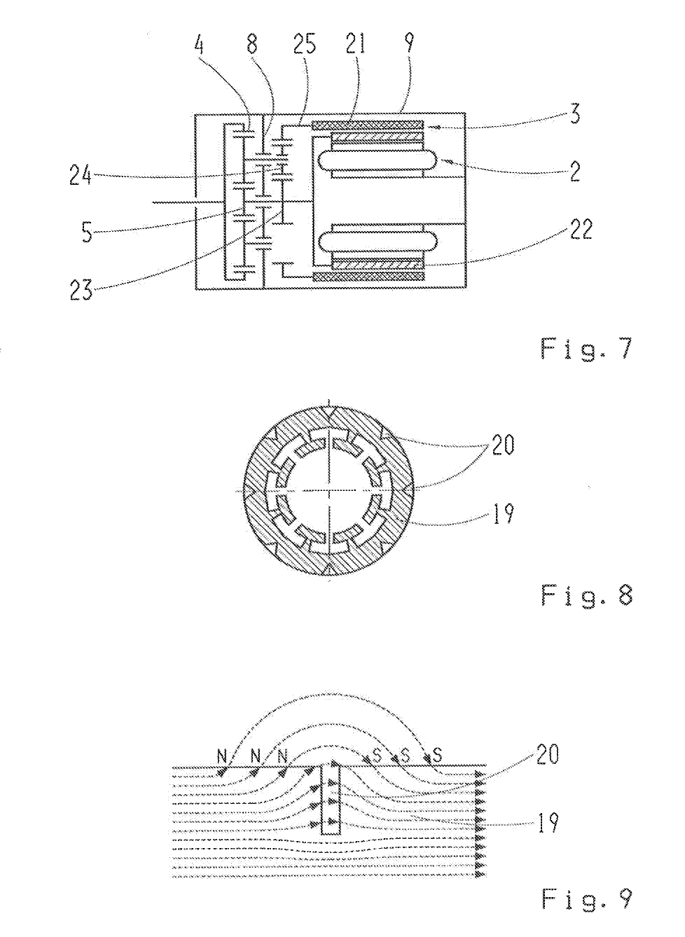

FIGS. 6 and 7 show two embodiment variants of the rotary damper, in which the electric machine 2 is in the form of an external-rotor machine. This type of electric machine 2 has the advantage that the eddy current brake 3 is contained within the rotor arrangement of the electric machine 2. The stator of the electric machine 2 is arranged on the inside of the rotor 6.

In FIG. 6, as its rotor 6 and eddy current brake 3, the electric machine 2 comprises a metallic cylinder, the inside of the cylinder that faces toward the stator being provided with a magnet arrangement and the outside of the cylinder facing toward a magnet arrangement fixed to the housing for producing the eddy currents. In this way the metallic cylinder of the external rotor 6 at the same time forms the eddy current brake 3, which is located in a magnetic flux by virtue of the magnet arrangement, for example in the form of a permanent magnet 16, fixed on the housing 9.

As in the previous embodiment variants, the lever that transmits the relative movement is connected to the ring gear 4 of the first planetary gear assembly 1. The sun gear 5 of the first planetary gear assembly 1 is connected to the rotor 6 of the electric machine 6, whereas the planetary carrier 8 of the first planetary gear assembly 1 is connected to the housing 9.

In FIG. 7 the electric machine 2 and the eddy current brake 3 constitute a multi-component rotor arrangement. The rotor arrangement comprises a metal cylinder 21 and a cylindrical magnet holding arrangement 22, arranged coaxially with one another with an air-gap between them. The magnetic flux in the rotor arrangement is produced by the metal cylinder 21, since the metal cylinder 21 and the cylindrical magnet holding arrangement 22 move in opposite directions.

As with the previous embodiment variants the lever that transmits the relative movement is connected to the ring gear 4 of the first planetary gear assembly 1, whereas the sun gear 5 of the planetary gear assembly 1 is coupled by way of a rotational-direction-reversing intermediate stage to the metal cylinder 21. Furthermore, the planetary carrier 8 of the planetary gear assembly 1 is connected to the housing 9. Since the sun gear 5 is connected to the metal cylinder 21 by way of an intermediate stage, the rotational directions of the metal cylinder 21 and the magnet holding arrangement 22 are different.

For example, the intermediate stage can be formed by providing a further spur gear on the magnet holding arrangement 22, which is connected to the sun gear 5 in a rotationally fixed manner. The spur gear 23 engages with an intermediate gearwheel or planetary gear 24 mounted to rotate on the planetary gear shaft. In turn, the intermediate gearwheel 24 meshes with a ring gear 25 provided on the metal cylinder 21.

FIG. 8 shows as an example, a cross-section of a stator plate 19 of an eddy current brake 3 with a drum configuration. Around the outer circumference coaxially extending grooves 20 are provided, by which a desired stray flux for the eddy current brake 3 is produced. In the version shown the grooves 20 have for example a V-shaped cross-section.

FIG. 9 illustrates the physical principle for producing the stray flux by means of the grooves 20 provided, As can be seen from that figure, the magnetic field is correspondingly distorted by each groove 20. By virtue of the surrounding grooves 20 in the stator sheet 19 the stray flux is produced, since at the edges of each groove 20 north and south poles are formed.

### INDEXES

1 First planetary gear assembly
2 Electric machine
3 Eddy current brake
4 Ring gear of the first planetary gear assembly
5 Sun gear of the first planetary gear assembly
6 Rotor of the electric machine
7 Drum of the eddy current brake
8 Planetary carrier of the first planetary gear assembly
9 Housing of the rotary damper
10, 10A Disk-shaped plates of the eddy current brake
11, 11A Ring-disk shaped angled portions
12 Ring gear of a second planetary gear assembly
13 Second planetary gear assembly
14 Sun gear of the second planetary gear assembly
15 Planetary carrier of the second planetary gear assembly
16 Permanent magnet
17 First planetary gearwheels
18 Second planetary gearwheels
19 Stator plate
20 Groove
21 Metal cylinder
22 Magnet holding arrangement
23 Spur gear
24 Intermediate gearwheel
25 Ring gear
N North pole
S South pole

1-18. (canceled)

19. A rotary damper for a vehicle, for damping relative movements between vehicle wheels and a body of the vehicle, the rotary damper comprising:
at least one gear assembly that converts the relative movement into rotational movement, and
the at least one gear assembly being connected to at least one electric machine (2) to facilitate actively controllable damping of the relative movement.

20. The rotary damper according to claim 19, wherein at least one dynamic brake is provided for braking the electric machine (2).

21. The rotary damper according to claim 20, wherein the dynamic brake is at least one of an eddy current brake (3), a hydrodynamic brake and a clutch.

22. The rotary damper according to claim 20, wherein the dynamic brake is an eddy current brake (3), and the eddy current brake (3) is arranged one of:
in parallel with respect to a connection between the at least one gear assembly and the electric machine;
in series with respect to the connection between the at least one gear assembly and the electric machine; or
in a power-branched manner with respect to the connection between the at least one gear assembly and the electric machine.

23. The rotary damper according to claim 22, wherein the eddy current brake (3) is arranged in parallel with respect to the connection between the at least one gear assembly and the electric machine,
a lever, which transmits the relative movement, is connected to a ring gear (4) of the gear assembly which is a first planetary gear assembly (1), and for the parallel arrangement, a sun gear (5) of the first planetary gear assembly (1) is connected to a rotor (6) of the electric machine (2) and to the eddy current brake (3), and a planetary carrier (8) of the first planetary gear assembly (1) is connected to a housing (9).

24. The rotary damper according to claim 22, wherein the eddy current brake (3) is arranged in series with respect to the connection between the at least one gear assembly and the electric machine;
a lever, which transmits the relative movement, is connected to a ring gear (4) of a first planetary gear assembly (1) and, for the series arrangement, a sun gear (5) of the first planetary gear assembly (1) is connected to a rotor (6) of the electric machine (2) and to a ring gear (12) of a second planetary gear assembly (13), a sun gear (14) of the second planetary gear assembly (13) is connected to the eddy current brake (3), and a planetary carrier (15) of the second planetary gear assembly (13) is connected to a housing (9).

25. The rotary damper according to claim 22, wherein the eddy current brake (3) is arranged in the power-branched manner with respect to the connection between the at least one gear assembly and the electric machine, a
lever, which transmits the relative movement, is connected to a ring gear (4) of a first planetary gear assembly (1), and for the power-branched arrangement, a sun gear (5) of the first planetary gear assembly (1) is connected to a ring gear (12) of a second planetary gear assembly (13), a sun gear (14) of the second planetary gear assembly (13) is connected to the eddy current brake (3), a planetary carrier (8) of the first planetary gear assembly (1) is connected to a housing (9) and a planetary carrier (15) of the second planetary gear assembly (13) is connected to a rotor (6) of the electric machine (2).

26. The rotary damper according to claim 22, wherein the eddy current brake (3) is arranged in the power-branched manner with respect to the connection between the at least one gear assembly and the electric machine,
a lever, which transmits the relative movement, is connected to a ring gear (4) of a first planetary gear assembly (1), and for the power-branched arrangement, a sun gear (5) of the first planetary gear assembly (1) is connected to a ring gear (12) of a second planetary gear assembly (13), a sun gear (14) of the second planetary gear assembly (13) is connected to the eddy current brake (3), a planetary carrier (8) of the first planetary gear assembly (1) and a planetary carrier (15) of the second planetary gear assembly (13) are both connected to a housing (9), and the second planetary gear assembly (13) has a double planetary set such that, respectively, first planetary gearwheels (17) of the double planetary set engage with the sun gear (14) of the second planetary gear assembly (13) and with the ring gear (12) of the second planetary gear assembly (13), and second planetary gearwheels (18) of the double planetary set engage with a rotor (6) of the electric machine (2).

27. The rotary damper according to claim 21, wherein the eddy current brake (3) comprises a drum (7) made from a magnetic material, which is arranged coaxially with the rotor (6) of the electric machine (2) so that the electric machine (2) is surrounded by the drum (7).

28. The rotary damper according to claim 27, wherein when the eddy current brake (3) has a drum-shaped configuration, a plurality of recesses are distributed around an outer circumference of a stator plate (19) of the electric machine (2) and produce a stray flux in a magnetic field.

29. The rotary damper according to claim 28, wherein the plurality of recesses in the stator plate (19) are axially extending grooves (20).

30. The rotary damper according to claim 21, wherein the eddy current brake (3) comprises two disk-shaped plates (10, 10A), and each of the two disk-shaped plates is arranged on a respective end side of the electric machine (2).

31. The rotary damper according to claim 30, wherein a stator of the electric machine (2) is axially extended and has at axially opposite ends thereof approximately ring-disk shaped angled portions (11, 11A), which are directed approximately parallel to the disk-shaped plates (10, 10A) of the eddy current brake (3).

32. The rotary damper according to claim 21, wherein permanent magnets (16) are arranged on a housing of the rotary damper and produce magnetic flux which produces eddy currents for the eddy current brake (3).

33. The rotary damper according to claim 21, wherein the electric machine (2) is an external-rotor machine with a metallic cylinder as a rotor (6) and an eddy current brake (3), a magnet arrangement is inside of the metallic cylinder facing toward a stator is and an outside of the metallic cylinder faces toward a magnet arrangement that is fixed on a housing of the rotary damper for producing eddy currents, a lever that transmits the relative movement is connected to a ring gear (4) of the gear assembly, formed as a first planetary gear assembly (1), a sun gear (5) of the first planetary gear assembly (1) is connected to the rotor (6) of the electric machine (2), and a planetary carrier (8) of the first planetary gear assembly (1) is connected to the housing (9) of the rotary damper.

34. The rotary damper according to claim 21, wherein the electric machine (2) is an external-rotor machine having a metal cylinder (21) and a cylindrical magnet holding arrangement (22) that are arranged coaxially with one another as a multi-component rotor (6) and with an eddy current brake (3), an air-gap is formed between the metal cylinder (21) and the cylindrical magnet holding arrangement (22), a lever that transmits the relative movement is connected to a ring gear (4) of the gear assembly formed as a planetary gear assembly (1), a sun gear (5) of the planetary gear assembly (1) is connected to the cylindrical magnet holding arrangement (22) and, via an intermediate stage that reverses a rotational direction, to the metal cylinder (21), and a planetary carrier (8) of the planetary gear assembly is connected to a housing (9) of the rotary damper.

35. The rotary damper according to claim 33, wherein at least one of a further stator, at least one permanent magnet and at least one coil arrangement is associated with the eddy current brake (3) as a magnet arrangement.

36. The rotation damper according to claim 21, wherein when the dynamic brake is either the hydrodynamic brake or the clutch, and a fluid which has a viscosity that varies by either an electric field or a magnetic field is used a medium for the dynamic brake.

37. A rotary damper for a vehicle, for damping relative movement between wheels and a body of the vehicle, the rotary damper comprising:
at least one gear assembly that converts relative movement between the wheels and the body of the vehicle into rotation movement, and
the at least one gear assembly being connected to at least one electric machine (2) such that damping of the relative movement is actively controllable.
